(19) United States
(12) Patent Application Publication
(10) Pub. No.: US 2025/0004846 A1
(43) Pub. Date: Jan. 2, 2025

(54) SYSTEMS AND METHODS FOR AUTOMATED BATCH IMPACT EVALUATION

(71) Applicant: ROYAL BANK OF CANADA, Toronto (CA)

(72) Inventors: Mark LUNA, Whitby (CA); Marat KHANDROS, Brooklyn, NY (US); AmirReza OGHBAEE, New York, NY (US); Ricardo CHAVEZ, Toronto (CA); Jakub KOLAKOWSKI, Toronto (CA); Ajay BRIJMOHAN, Ajax (CA); Harsh S. SHAH, Toronto (CA); Nick QUINTELA, Toronto (CA)

(21) Appl. No.: 18/758,946

(22) Filed: Jun. 28, 2024

Related U.S. Application Data
(60) Provisional application No. 63/524,396, filed on Jun. 30, 2023.

(51) Int. Cl. G06F 9/50; G06F 11/34; G06F 16/23

(52) U.S. Cl. CPC G06F 9/5038; G06F 11/3419; G06F 16/2386; G06F 2209/5021; G06F 2209/5022

(57) ABSTRACT

A computational tool is proposed that is adapted as an automated batch impact evaluator (ABIE). The computational tool, for example, can be configured to monitor and track batch processing, generating computational outputs that can be surfaced to a user or downstream devices in the form of computer interface or application programming interface.

### CROSS-REFERENCE

This application is a non-provisional of, and claims all benefit, including priority, from U.S. Application No. 63/524,396, filed 2023 Jun. 30, entitled “SYSTEMS AND METHODS FOR AUTOMATED BATCH IMPACT EVALUATION”. This document is incorporated herein by reference in its entirety.

### FIELD

Embodiments of the present disclosure relate to the field of computer processing, and more specifically, embodiments relate to computer devices, systems and methods for automated batch impact evaluation.

### INTRODUCTION

Data processes can be complex and executed on a range of computing devices and services. The data processes can include batch processing, which include batch flows and sub-processes, which can include automated execution of computing code. It is important to be able to track data and dependencies as the data processes can be linked together such that a delay in an upstream data process can have serious issues that impact the timing and viability of a downstream data process.

Batch processing can be challenging to model, as the interdependencies can be difficult to understand both in relation to occurrence and impact. Furthermore, some batch processes have redundancy and support mechanisms. While batch processing can occur for mainframe computing systems, batch processes can also run on other types of architectures and technologies. Analyzing batch processes manually is error prone and resource intensive, and may fail to identify deeper issues that result from complex dependencies.

### SUMMARY

Approaches are proposed herein for computational systems and methods for automated batch computing process impact evaluation and, in some embodiments, automated remediation. In particular, a computer implemented system for automated batch data process impact evaluation is proposed that can be operated on computing hardware, such as a computer server or a mainframe device. The computing hardware includes a computer processor operating in conjunction with computer memory.

The approach is conducted on computerized batch processing, where software processes are run in execution jobs that are batched together. Computerized batch processing is a highly scaled set of computing tasks that are run on high volume processing, and need to be conducted accurately and efficiently In particular, the batch processing is run as computerized scripts, which control the timing and execution parameters of the batch processing. A challenge with batch processing is that the computerized tasks may be interdependent (e.g., the output of one task is an input into a subsequent task), and there is often limited computing time and resources available to run the task. Example batch processes include computerized reconciliations, transaction settlements, error handling, data logging, computerized insight generation, among others. These can occur in a limited time window, such as during non-business hours, overnight, etc., and significant computing resources are utilized in conducting a high volume of determinations.

When there is a failure (e.g., execution failure, operational failure, processing failure), downstream batch computing processes may be delayed and the entire batch process may fail. Accordingly, the batch processes are managed by an overseer computer process, which handles scheduling, re-scheduling, fault tolerance, and scalability required for high volume processing, orchestrating the use of computing resources to expedite certain processes in an effort to satisfy a timing constraint or computing constraint. Accordingly, additional computing resources can be assigned to critical data processes that have been delayed to avoid a further delay.

The assignment of computing resources can be conducted dynamically, based on a determination of overall batch process impact. For example, if a downstream batch process requires two inputs to run, and a first input is delayed, and the second input is already available, the overseer process may automatically expedite the predecessor batch process providing the first input. On the other hand, if the second input is not yet available, the overseer process may expedite other processes as expediting the first input would not improve overall execution due to the dependency on the second input. Timing the batch process jobs is an important tool in improving the overall computing efficacy given a finite set of computing resources and timing. An overall objective is to improve an impact weighted latency related aspects from the overall execution and computer processing of a large number of independent computational data processes operating as batch job processes. Different tasks can be assigned different weights from an importance/criticality perspective, and in the event of a serious failure, the system can automatically take or generate instruction sets for confirmation thereof for remedial action, which can include automatically processing decisions to reschedule, delay, or expedite certain batch processes through the dynamic assignment of computing resources.

The system is configured to extract operational logs corresponding to execution of data processes representing batch data process jobs. The operational logs can include fields corresponding to batch flow status, batch flow payload, and batch flow schedule. These operational logs can be used to monitor execution progress and process characteristics, and in some embodiments, are provided as a stream of data frames or data structures having corresponding data objects therein representing a state of a particular batch process job. The data frames or data structures can include additional augmented metadata fields which can be used for improved batch process control. These operational logs are tracked using specific monitoring subprocesses, which can run alongside or on top of data processes and track execution characteristics and/or errors/exceptions that are raised. The operational logs can be exposed through an API as a stream of data objects, such as periodic heartbeat data objects, which can be processed periodically to generate updated dependency and timing data objects as described in various embodiments herein.

As described herein, in some embodiments, the data objects can then be processed to generate an updated nodal data structure providing a transformed variation of a representation of the batch processes and dependencies for improved computational speed during runtime operation where computing resources and time are limited. Accordingly, an improvement to the technical process is possible.

Where the updated nodal data structure, when traversed, indicates an issue, such as the expected runtime falling outside of the available runtime window due to expected re-processing and failures, an estimated impact value of each batch data process job of the one or more batch data process jobs can be identified and can be used for a weighted approach for failure handling, which can include automatic generation of control instructions (which can be automatically executed or executed upon confirmation). Historical execution characteristics and parameters can be used for probabilistic failure estimation whereby node traversals are coupled with failure probabilities and remediation step probabilities to automatically take into account failure modes that occur with batch processing, such as hardware failure, drive failures, a need to switch to a backup data source, among others. As a larger corpus of historical data becomes available, the modelling of failure estimation can improve and provide a stronger estimate of success/failure metrics and probabilities.

In some embodiments, all nodes are presumed to have a pre-defined (e.g., 100%) success rate, and these are tracked against real-world execution parameters alongside factors such as average hardware age, load, temperature, network congestion level, etc., to reduce the overall success rate modelled over time. Accordingly, in a failure situation, remedial steps may include a partial or full re-execution of the data process, or a fallback to another data source, using previous (potentially stale) data, among others, which can also be flagged from a data lineage perspective to track potentially reduced data quality (a useful approach where data does not significantly change from batch run to batch run).

The remedial steps can be factored into the branch traversal—e.g., while success means that the batch process concluded successfully, failure may trigger a looping remedial situation and apply a probabilistic expectation to the required execution time. As the process can indefinitely model for failures and remediations thereof, in some embodiments, an input parameter to the batch execution process may include pre-defining a limit to the number of levels of analysis. For example, the model can be programmed to only analyze to a depth level of 2 for failures and their remediations.

Execution of the one or more data processes is monitored to identify differences with the fields corresponding to the batch flow schedule. An alert, notification, or control instruction can be generated in different scenarios, for example, such as if weighted differences in timing of the batch flow schedule exceeds a pre-defined threshold, the weighted differences weighted based on the estimated impact value of each batch data process job. A graphical user interface can be provided having interactive interface control elements rendered.

In an embodiment, the control instruction includes re-allocating available computing resources to reduce the weighted differences in timing of the batch flow schedule by expediting a subset of the one or more batch data process jobs through allocating additional computing resources. This can be used as an automated attempt to control process self-healing approaches for reducing weighted impacts on a schedule by expediting certain batch process operational characteristics. Expediting can include spinning up or obtaining (e.g., at a higher cost) additional computing resources, including operationalizing further hyper-threads for improved parallel processing, or partitioning an existing job for parallelization.

In some embodiments, the system identifies one or more batch flow dependencies from the fields corresponding to the batch flow schedule. The one or more batch flow processes and batch flow dependencies can then be stored or modelled as a set of interconnected nodal data objects that are traversed during the identification of the differences with the fields corresponding to the batch flow schedule. The weighted differences to a schedule can then be generated based on a traversal of the interconnected nodal data objects, and the traversal of the interconnected nodal data objects includes generating a probability adjusted path weight based on probability metadata stored thereon each of the interconnected nodal data objects indicative of historical success or failure event data.

In some embodiments, the re-allocating of the available computing resources is prioritized for a currently dispatched batch data process having a highest estimated impact value. In some embodiments, the interactive control elements include one or more graphical display options that are modified based at least upon the weighted differences in timing of the batch flow schedule for the corresponding nodal data object. In some embodiments, the re-allocating of available computing resources includes requesting additional available computing resources to be provisioned. In some embodiments, the re-allocating of available computing resources includes re-assigning computing resources from lower impact batch data processes.

For example, instead of conducting a settlement reconciliation across all branch computers of a financial institution sequentially, an expedited variant can include sharding the branch computers into partition groups, and splitting the batch process into sub-batches for parallel processing while recruiting additional computing resources to conduct the parallel processing. This can be useful where a serious failure occurred earlier in the evening, and the processes need to operate faster to be able to reconcile before the next morning. As noted herein, because there a nodal graph is generated that is impact weighted, the system can be configured to automatically deprioritize and re-prioritize certain tasks based on different pre-defined characteristics stored in metadata, such as transaction volume amount, a pre-defined business criticality level, among others.

The batch process monitoring and control tool described herein can be implemented in the form of a specialized computing apparatus that operates as a supervisor or overseer data process, coupled to individual computing resources operating the batch processes through a message bus or distributed computing network where data objects representing execution logs or batch computing process characteristics can be obtained, for example, by polling or interrogating the batch process or batch process monitors through corresponding application programming interfaces.

The specialized computing apparatus can maintain on a non-transitory computer readable storage medium a data structure having interlinked data objects based on the execution logs or batch computing process characteristics, such as a nodal structure described herein with additional metadata or augmented functionality provided through additional data elements appended to the nodal data objects. The nodal data objects can then be traversed to generate expected execution times, delays, etc., and those can be rendered on a corresponding graphical user interface through visual interactive elements.

In some embodiments, where the expected execution times, delays, exceed thresholds, the system can be configured to automatically execute remedial processes or generate remedial instructions for a confirmation which when executed, automatically change execution parameters of the underlying batch processes by dynamically assigning or reassigning computing resources and priority, as well as potentially rescheduling or flagging a batch process for low data quality (e.g., if a high quality source is not available and swapped for a low quality/stale data source so that the report process can be run by the execution deadline).

The specialized computing apparatus can reside in a data center and can be electronically coupled to downstream computing resources and batch processing machines, and in some embodiments, can be a computer software that can control resource allocation, such as a hypervisor, a supervisor system, or a supervisor of supervisor systems, which propagate instruction sets and execution commands that are utilized to modify computer execution aspects such as hardware control and operating system control.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an example flow diagram showing an example job schedule and a series of batch jobs, shown overlaid over a flow execution timeline, according to some embodiments.

FIG. 2, a mainframe process is shown relating to “ZEKE Event Status Info”, and job statuses can be tracked, for example, through a runtime log corresponding to the specific batch flow that can track the progress and process of each batch job in the batch flow.

FIG. 3 is an example data flow pipeline for an ABIE system implementation, according to some embodiments.

FIG. 4 is an example dashboard that can be generated based as a system output, according to some embodiments.

FIG. 5 is an example document showing an example log output 500, according to some embodiments.

FIG. 6 is an example batch flow schedule and dependency map that can be generated as a system output, according to some embodiments.

FIG. 7 is an example dashboard for generating an estimated impact for a particular batch flow or set of batch jobs (or relating to an issue thereof), according to some embodiments.

FIG. 8 is an example computing architecture for providing an automated batch impact evaluator system, according to some embodiments.

FIG. 9A and FIG. 9B is an illustration depicting an example process flow, according to some embodiments. FIG. 9A extends to FIG. 9B.

### DETAILED DESCRIPTION

A computational tool is proposed that is adapted as an automated batch impact evaluator (ABIE). The computational tool, for example, can be configured to monitor and track batch processing, generating computational outputs that can be surfaced to a user or downstream devices in the form of computer interface or application programming interface. For example, the system outputs can be transformed into a graphical user interface providing “a single pane of glass” that visualizes batch flow dependencies, batch flow dependencies, batch flow statuses, and/or other information, such as an estimated impact value. The proposed approaches are computational systems and methods that are adapted to reduce issues related to investigation of job failures & mainframe incidents.

Specific monitoring and logging components are described that are used as a feed for computational intelligence regarding batch job statuses, and these can be aggregated and computationally analyzed to assess batch process viability and operational information. Batch processes can include various computing processes that can be run periodically to conduct various computational tasks, such as high-volume repetitive tasks. These computational tasks can include backups, filtering, sorting, and are part of critical end-of-day computational processes that support various enterprises. The batch jobs often have dependencies on one another, and a series of batch jobs that have dependencies on each other is called a batch flow.

Batch flows can run on specific batch schedules, and from a computational perspective, batch jobs can have fields representing codes or job statuses that return indications, such as an indication of success or failure (or partial success/failure thereof). A technical challenge that arises with batch processing is that jobs within a flow can fail or get delayed which can have deleterious impacts. These impacts can be measured in terms of business impact, but not necessarily so for all embodiments.

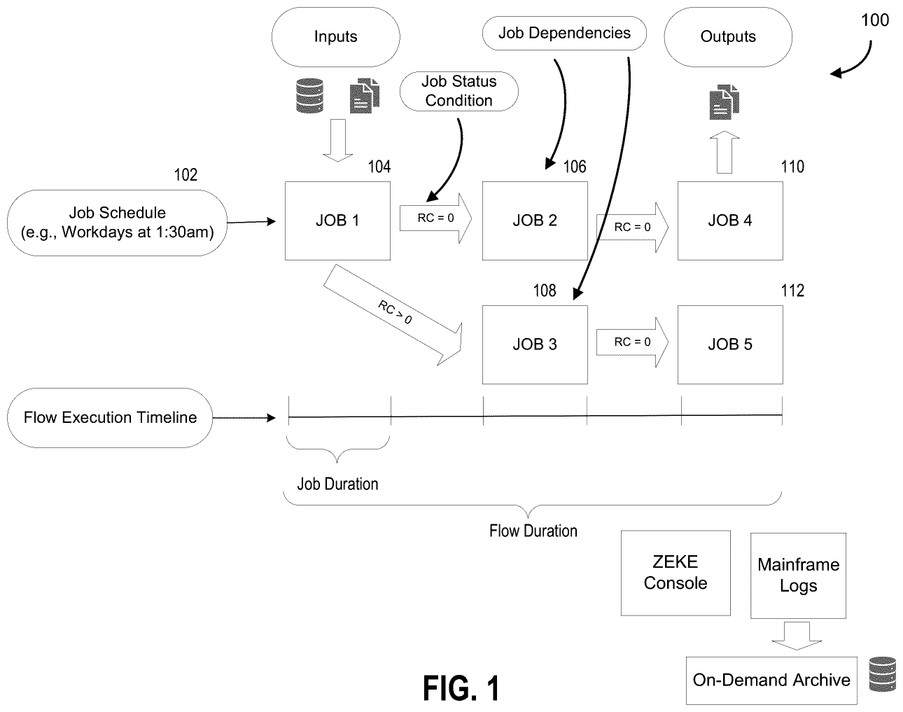

FIG. 1 is an example flow diagram showing an example job schedule and a series of batch jobs, shown overlaid over a flow execution timeline, according to some embodiments.

In FIG. 1, the flow diagram 100 shows a job schedule 102, batch job 1 104, batch job 2 106, batch job 3 108, batch job 4 110, and batch job 5 112. Each of these batch jobs can receive various inputs, and when processed, return job status conditions. In this example, batch job 2 106 and batch job 3 108 are dependent on batch job 1 104. The status conditions are noted as RC (return condition), and a RC=0 means a successful run and a RC>0 in FIG. 1 means that a failure has occurred. Namely, anything other than RC=0 is a type of failure. Batch return conditions, for example, can be different flagged outcomes, and do not necessarily need to be returned by the process itself. For example, in some situations, the system is configured to note any process that has taken over a certain period of time or duration to have potentially been stuck or timed-out.

As shown in FIG. 1, because of the dependencies, the running of the batch jobs can be run in parallel or in series, or various combinations thereof, and in some embodiments, the batch jobs are also conditional depending on an output or status of an earlier job. For example, a batch job may only run when there is a failure or a success, or, in some embodiments, if an error code returns that there has been a particular amount of delay, etc.

Batch jobs, for example, can include end of day activities that are conducted, such as batch data processes that run backups of the day's transactions, data analytics processes that aggregate or otherwise generate insights based on the day's transactions, error control processes that check for errors and inconsistencies, etc. In some embodiments, the batch jobs themselves generate outputs such as reporting information, etc.

A practical example of a batch job can include those that are run at end of day during off-hours or on weekends for a financial institution, and the underlying information can include records of transactions that were kept or generated in relation to transactions that occurred during the day or the relevant period of time. The batch processes can be used during times when computing load is reduced (e.g., during off hours) such that efficient computing resources can be utilized. The batch processes can include generating financial planning insights, conducting machine learning/artificial intelligence training, generating backup copies for long term storage, generating reporting data that is used for storing regulatory records or conducting anti-money-laundering data processes, among others.

The transactions can also include, for example, transactions relating to financial trading data, and these can similarly be aggregated and analyzed as part of batch processing.

The batch processing does not necessarily need to run during off hours, and the batch processing, in some embodiments, can also include processes that are run in real or near-real time or during peak computing usage. In some embodiments, the speed of the batch processing can vary based on the amount of computing resources allocated towards a particular task or settings associated with the running of the batch data process (e.g., desired resolution of analysis), and furthermore, the speed of the batch processing can be controlled and orchestrated to a degree in some variations. For example, to meet a desired time constraint, additional computing resources can be assigned to the running of various batches to avoid a deleterious impact.

Another use-case includes batch dependency management through process orchestration. By identifying failure in dependent jobs, various processes can be triggered with proper timing controls in place. For example, failure in dependent jobs can be indicative of a particular failure type, and multiple dependent job failures may trigger a remediation or investigation activity either at the individual failed jobs, or on the parent jobs, or on the downstream jobs upon which a failure will have a downstream effect. These processes may operate with various timing controls and can include running backup jobs, alternate jobs, failsafe versions of jobs, etc. The failed jobs can be restarted, can be simplified (e.g., if there isn't enough time or computing power remaining to conduct a job at full resolution, a parameter can be switched to use a simplified or heuristic version instead). Other timing controls can include assigning more resources to speed up a restarted job. Another type of remediation action can include turning on additional debugging/logging processes for future runs to help identify a cause of failure.

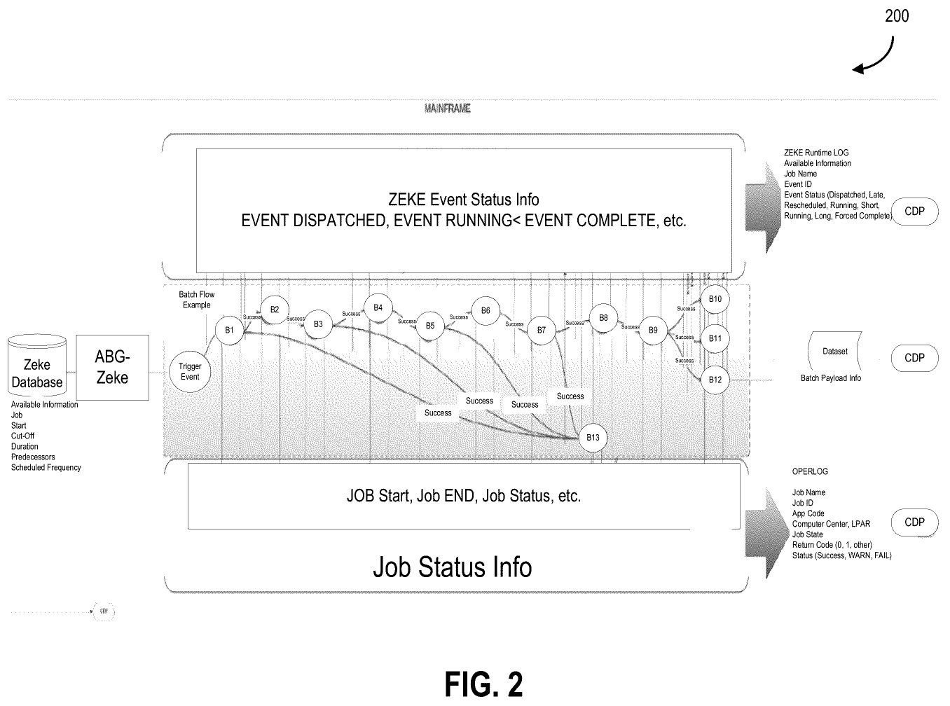

The example from FIG. 1 is highly simplified, and FIG. 2 shows a practical real-life example. In FIG. 2, a mainframe process is shown relating to “ZEKE Event Status Info”, and job statuses can be tracked, for example, through a runtime log corresponding to the specific batch flow that can track the progress and process of each batch job in the batch flow. As shown in FIG. 2, there can be a significant number of batch processes being run at any given time, and the batch processes can be highly computing resource intensive.

Accordingly, as described in some embodiments, an impact analysis tracker can be maintained that generates an impact score estimate for a particular batch or a change in batch process flow, and these can be utilized by a batch impact orchestrator device to control how computing resources are allocated in an effort to improve overall batch processing based on the evaluated data. Impact tracking can be based, for example, on different types of criticality associated with the flows. These can include technical impacts, such as overall compute cost and time, but in some embodiments, volumetric impacts can also be tracked, such as the overall number of user accounts affected. The system can be operated with batch processes relating to legacy and highly critical transactions, and these can include, for example, payment transactions, transfers, credit ratings updates, etc. In terms of volumetric impacts, the underlying data can be interrogated to understand the total number of payment transactions impacted, transfers, credit ratings, etc. that are being impacted so that resources can be intelligently allocated in the event of a failed process.

In FIG. 2, the following information can be tracked across or in batch service flows.

### Zeke Scheduling Data

Job Name
Schedule Start Time
Scheduled cut-off time
Predecessors
Successors
Scheduled Frequency

### Operational Meta Data

Job Name
App Code
LPAR
Job State
Return Code
Job+Event Status

### Impact Information

### Sum of Dollar Amount Contained in Every Batch Run

In some embodiments, specific types of transactions can then be prioritized for batch process orchestration priority. For example, internal reporting/logging failures can be deprioritized in favor of external facing payment transactions. For example, in a scenario where there are a set amount of additional computing resources for expediting certain lagging processes (or restarting failed processes to be re-run), these additional computing resources can be allocated towards higher impact batch operation scenarios or identified higher impact batch flows. In this example, different tasks can be assigned different impacts based on specific objectives, and certain tasks can be rearranged, or rescheduled in addition to being expedited. For example, a high impact batch job may include running after hours financial transactions for clearing at a clearinghouse, and these jobs may be high value. Low value jobs can be rescheduled and/or delayed, for example, shifted to a weekend or a holiday.

The value can be modelled based on the underlying dollar value of the transactions, or based on the financial cost of not completing the transactions in time (e.g., penalty costs). On the other hand, a medium impact batch job can include conducting business as usual data backup and disaster recovery tasks, and a low impact batch job can include generating reporting/analysis for internal reporting or employee incentive tracking. Each branch scenario for batch execution can be analyzed for overall impact based on probabilities of success/failure, and as the batch is being executed, this impact estimate can be periodically or continuously generated. For example, the impact estimate can be re-generated as triggered at specific timing milestones or at specific completion (failure or success). Where there is a serious failure, even business critical tasks such as disaster recovery, backups, etc., may be rescheduled or deprioritized.

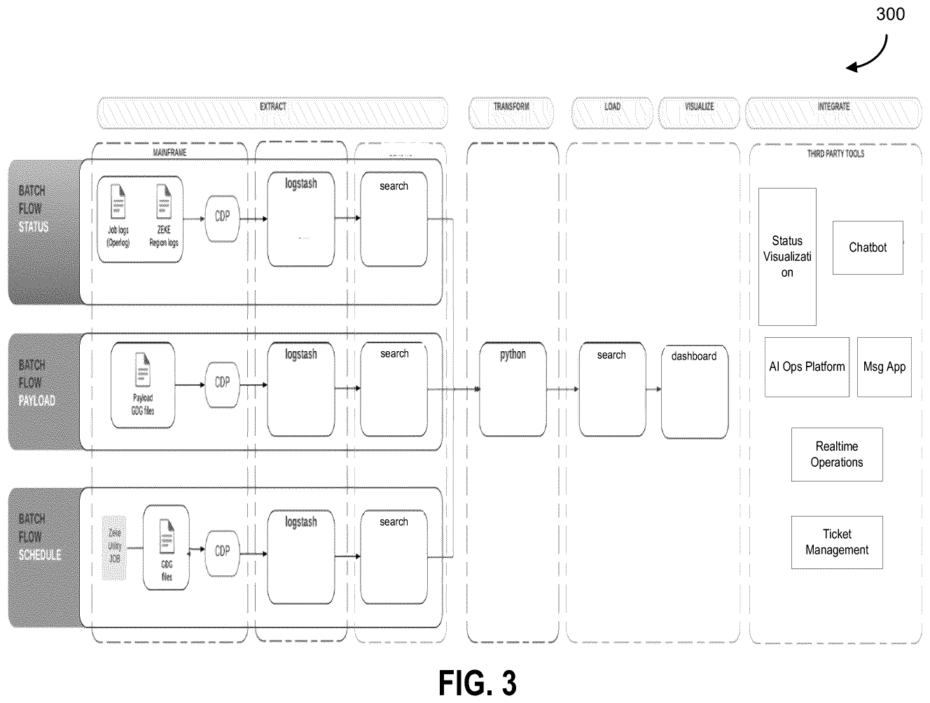

FIG. 3 is an example data flow pipeline for an ABIE system implementation, according to some embodiments. The data flow pipelines provide logging information which can be used, for example to track the batch flow status, payload, and schedule. Batch flow payload information can be used for impact tracking, among others. The batch flow schedule, in some embodiments, can be used to track expected vs. actual schedule, and in some embodiments, may also be used against historical information to establish expected scheduling and/or comparisons against allocated computing resources (which can then be used for expediting a batch process as needed).

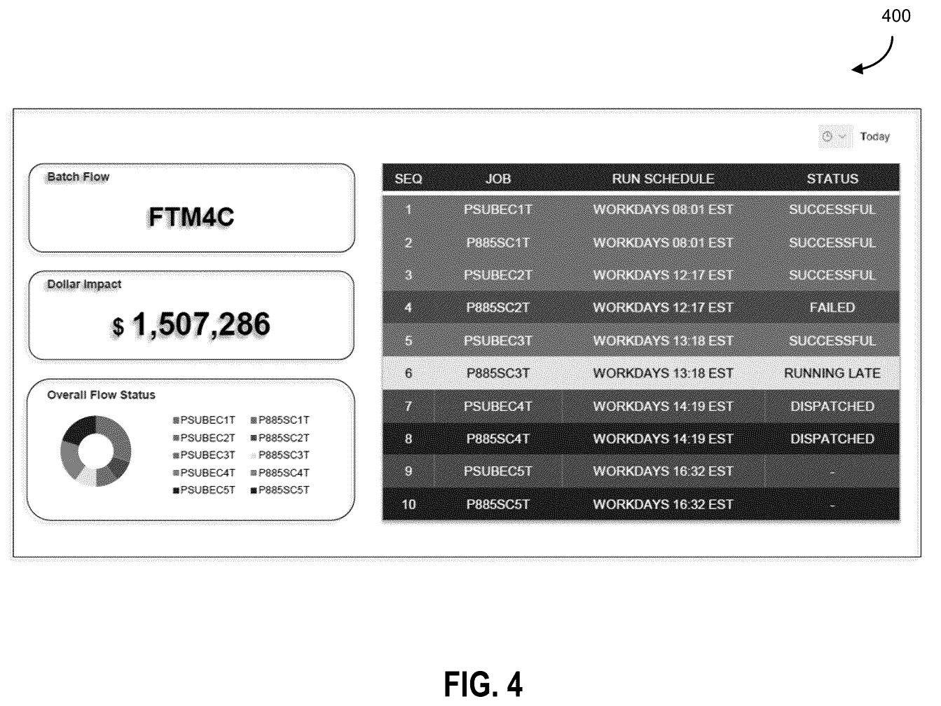

FIG. 4 is an example dashboard that can be generated based as a system output, according to some embodiments. In FIG. 4, dashboard 400 is a graphical user interface having visual interface control elements rendered thereon and receiving user inputs, and it provides a way to visualize mainframe data and mainframe dependencies in the form of an observability dashboard. As shown in FIG. 4, a batch flow identified as FTM4C is a flow that has a set of run schedules for underlying batch jobs (each having a sequence identifier), and a total dollar impact (e.g., based on batch flow payloads of the batch flow jobs). Status identifiers can be provided, and in this example, SEQ 4 has failed, and thus SEQ 6 may be running late due to a dependency. In some embodiments, an overall estimated run schedule after delays and failures may be established, and this can also be managed or manipulated by an orchestrator process that manipulates the order and computing resources allocated to particular batch jobs. For example, job orders can be re-arranged, delayed, expedited, or cancelled.

The dashboard 400 is a decision making tool that aids in understanding overall service health and availability difficult and constrains potential improvements to end to end proactive incident avoidance and incident resolution. When an incident occurs that is related to job failures, the upstream/downstream investigation to understand dependencies and impacts can use the tool for visualizing job scheduling and associated dependencies to applications/services introduce efficiency into the support functions.

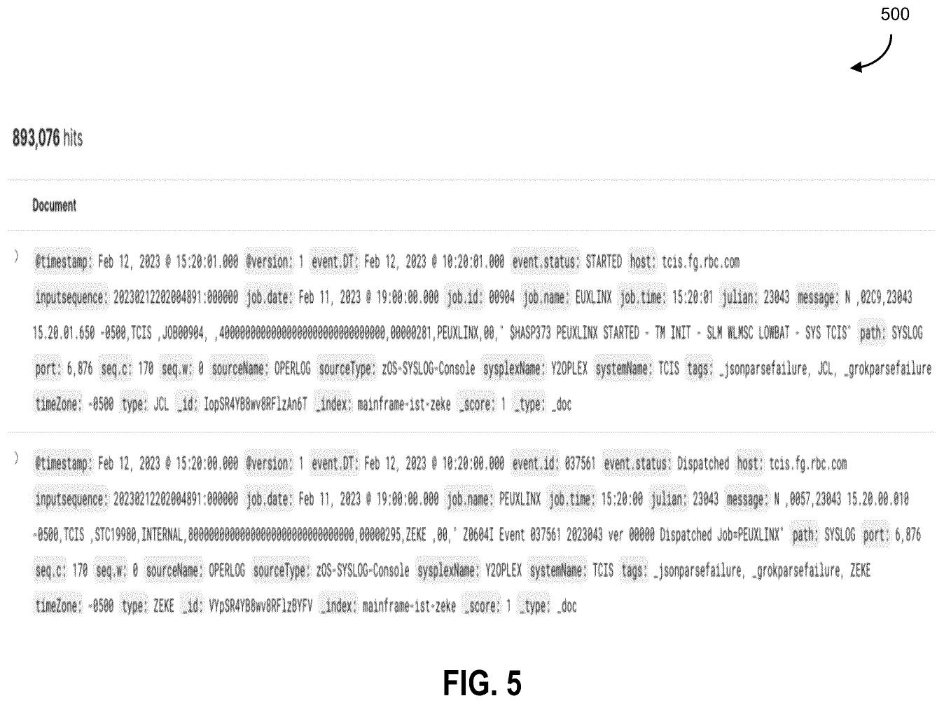

FIG. 5 is an example document showing an example log output 500, according to some embodiments.

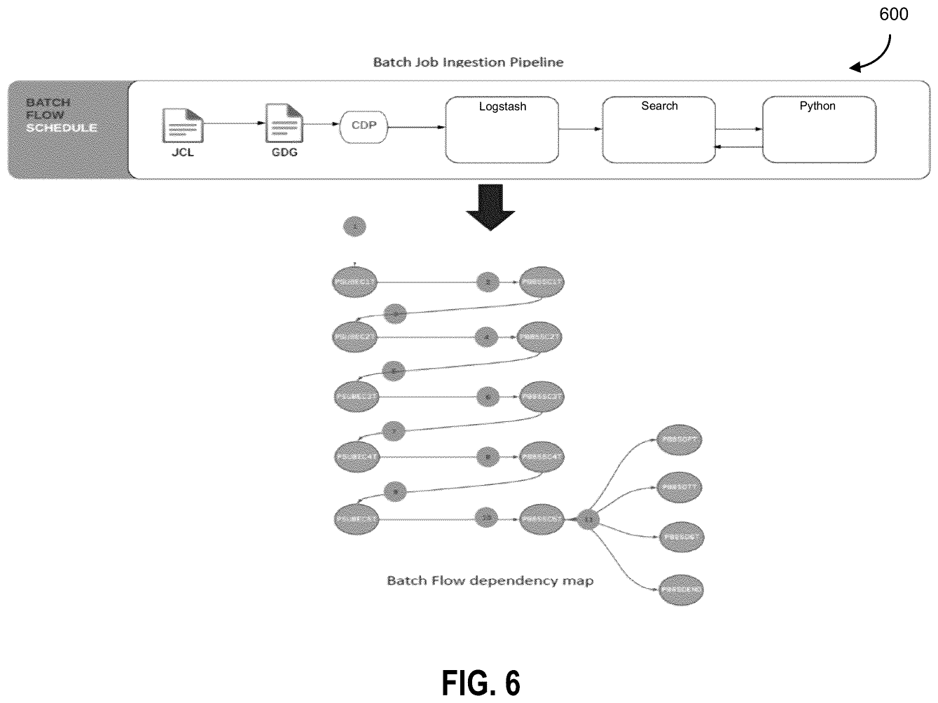

FIG. 6 is an example batch flow schedule and dependency map 600 that can be generated as a system output, according to some embodiments. The flow dependency map 500 can be visualized as a set of interconnected job nodes.

As shown in FIG. 6, some of the dependencies can be sequential, while others can be run in parallel.

In FIG. 6, the ZEKE utility is run automatically to query event scheduling information on the ZEKE system, and the results of the query can be put into a mainframe data set. The mainframe data set is fed automatically to a logstash instance, which feeds the data into an ABIE search mechanism (e.g., ABIE elasticsearch) for indexing, and a script can then use these elastic indices to construct a dependency map for any particular batch flow. An example process can include few different Pythons job process flows that are processed in accordance with batch instruction logic. A dependency map can be available for different parts of logic instructions and utilized for dependence tracking and updating.

The dependency map is a data object representing interconnections between different processes, identifying the specific inputs to the computational process required to be provided before a particular process can be run. As shown in FIG. 6, the process can be computationally complex, as different processes may feed into downstream processes, and the dependency chain can be quite long for highly scaled processes. The dependency map data object is configured to be traversable by a overseer data process for batch impact evaluation and downstream rescheduling.

The tool, in some embodiments, provides graphical user interface control elements that enable a user to understand what the critical batch flow dependency chain is, showing visualizations for batch jobs, and batch schedules. As described, in further embodiments, and it will be configured to detect the dollar value impact of a flow and/or a flow event (e.g., delays to certain jobs, job failures). The initial discovery of all running flows can occur in ABIE's metadata ingestion jobs in which the system is configured to review the scheduling and ownership information of any given jobs and events on the mainframe platforms. This mapping will then be visualized along with the job status on a dashboard. The discovery process can be conducted periodically based on the process characteristics. In another embodiment, the discovery process is conducted during periods of low computing traffic and conducted on dummy versions of the batch processes to computationally identify potential dependencies as the dependencies may not always be readily apparent in technical specifications or schemas.

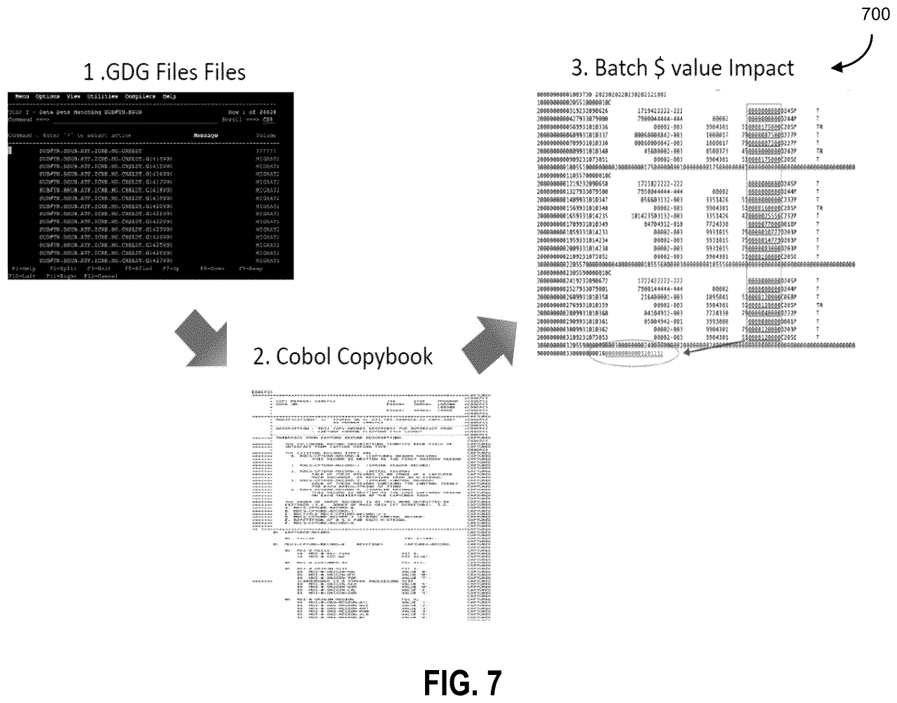

FIG. 7 is an example dashboard for generating an estimated impact for a particular batch flow or set of batch jobs (or relating to an issue thereof), according to some embodiments.

Mainframe information is not easily translated into business impact. Many critical flows have been around for years and while redundancy and support mechanisms are built on them, we just can't visualize it outside the mainframe world. Democratizing mainframe batch flow data (status, schedule, dependencies) to a modern data visualization tool is a useful benefit for ABIE. These flows are usually attached, for example, to various transactions that could represent a large sum of money.

The ability to present the dollar value impact on a single pane of glass is a crucial capability of this solution. Furthermore, a novel, easy-to-use flow addition procedure is proposed to enable plug-and-play support for potential future flows. Lastly, making metadata and operational logs available for a highly secured application without introducing any vulnerabilities will democratize the use of data paving the way for further enhancements and future improvements.

In the dashboard of 700, the impact (in this example, dollar value) for a specific batch flow, such as FTM4C, is identified. The batch flow can include moving input file creation (ICRE) files from FTM4C Unix systems to a data storage mechanism (EDCD). The ICRE files can contain, for example, debit/credit information from multiple client transactions. A copybook data object can be used where the data object includes instructions or explanations thereof in relation to how to read/extract dollar amounts from the ICRE files. Accordingly, the system can be configured to automatically extract an estimated impact proxy, such as a dollar amount, from each batch flow and associate each batch flow with the dollar amount for downstream impact analysis.

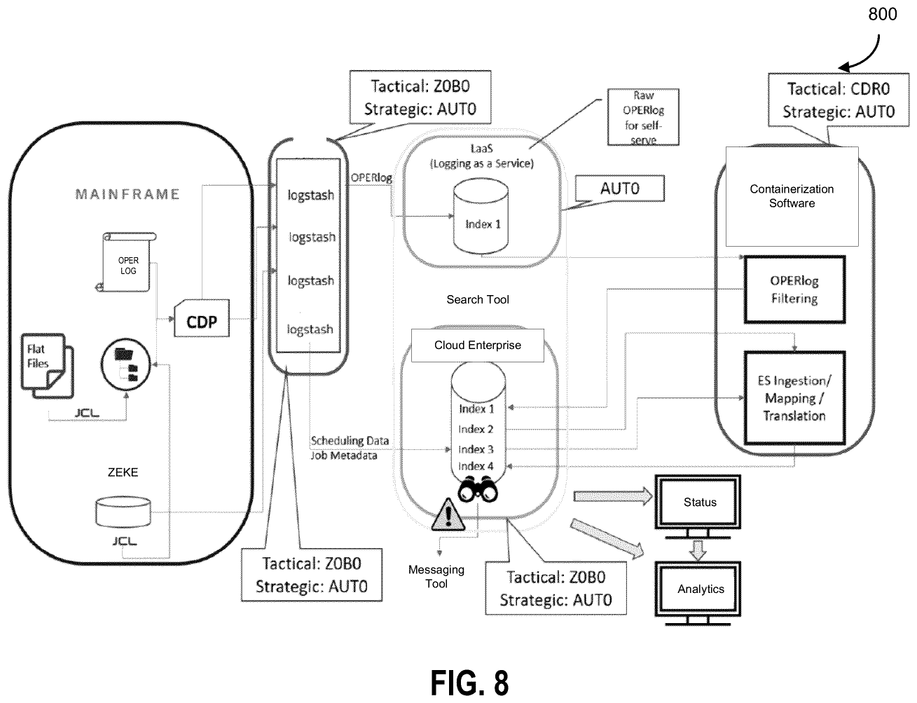

FIG. 8 is an example computing architecture for providing an automated batch impact evaluator system, according to some embodiments. The computing architecture is shown in example, and other, different, or alternate components can be utilized.

In this example, a mainframe system 802 is provided that is configured to have one or more data processing pipelines that output process logs (e.g., generated through logging as a service) mechanisms, and scheduling/metadata are provided to an enterprise system tracking mechanism which is configured as an orchestrator for managing and tracking the operation of various batch jobs. The enterprise system tracking mechanism can be configured as an enterprise data warehouse that is coupled to a portal mechanism, such as a status portal or a visualization tool such as Kibana™. The logs can be stored and managed, for example, using containerization platforms that control how applications are managed and deployed at scale.

The system 800 is configured to implement proactive alerting based on job dependencies and job statuses.

The system 800 operates first by initially identifying the core flows, and for each flow, the system 800 discover the series of jobs and their order that need to be completed successfully in a given time period. Then the real-time logs will be ingested to identify jobs status. This can be done by the mainframe system 802.

Finally, by utilizing the discovered metadata for each job, precisely job ID, the system is configured to tie back each log to its proper location in the flow. This step can be done by a cloud enterprise solution, such as Elastic Cloud Enterprise™. The system 800 can now represent the detailed status of all jobs involved in a flow and also notify relevant teams in case of a failure which will be reflected as an error while parsing the log messages.

The system can then be configured to aggregate and display financial impacts associated to job failures as each job failure will be reflected in the flow dashboard. Each flow can have the impact (e.g., estimated business or financial impact) attached to it and be configured for discovering any job failures that are mapped to the flow, highlighting the impact of the failure on the UI. Exporting logs and scheduling data from the mainframe and correlating dependencies in real-time bridges the visibility gap on batch flows and increases the speed of detecting potential issues. Using modern monitoring tool to provide transparent real-time monitoring and alerting is another potential advantage of the proposed approach.

A notification engine can then be integrated with various messaging and alerting systems reducing the detection time for potential high-priority incidents.

In diagram 800, the interconnecting physical computing devices are shown in example. In this example, the system can operate as a computing platform that is made available to an enterprise system, and an example can include

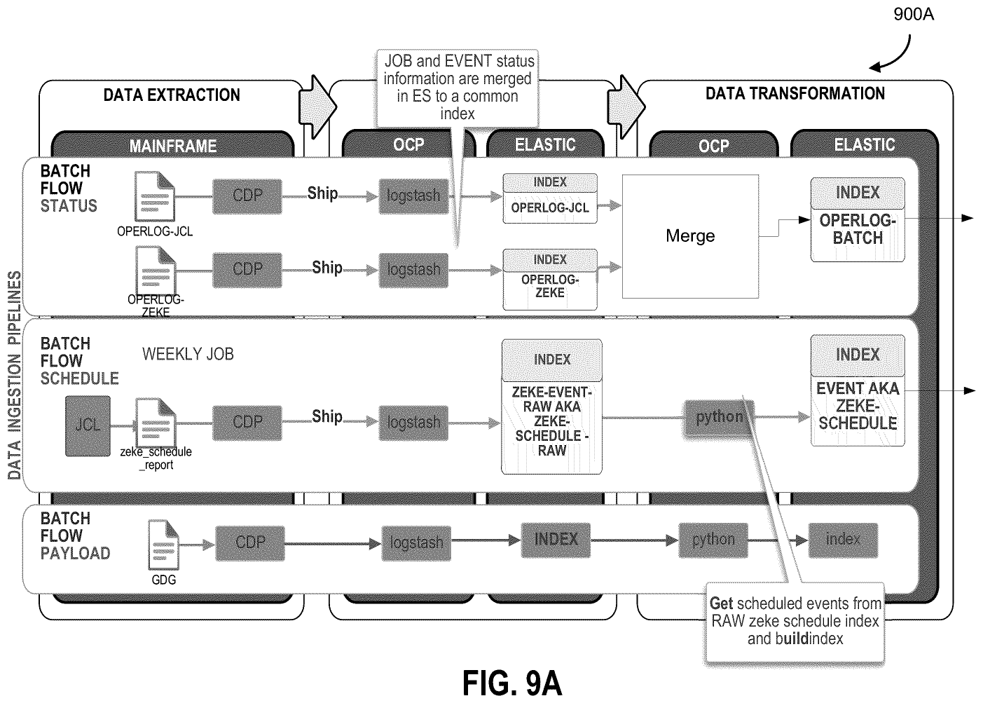

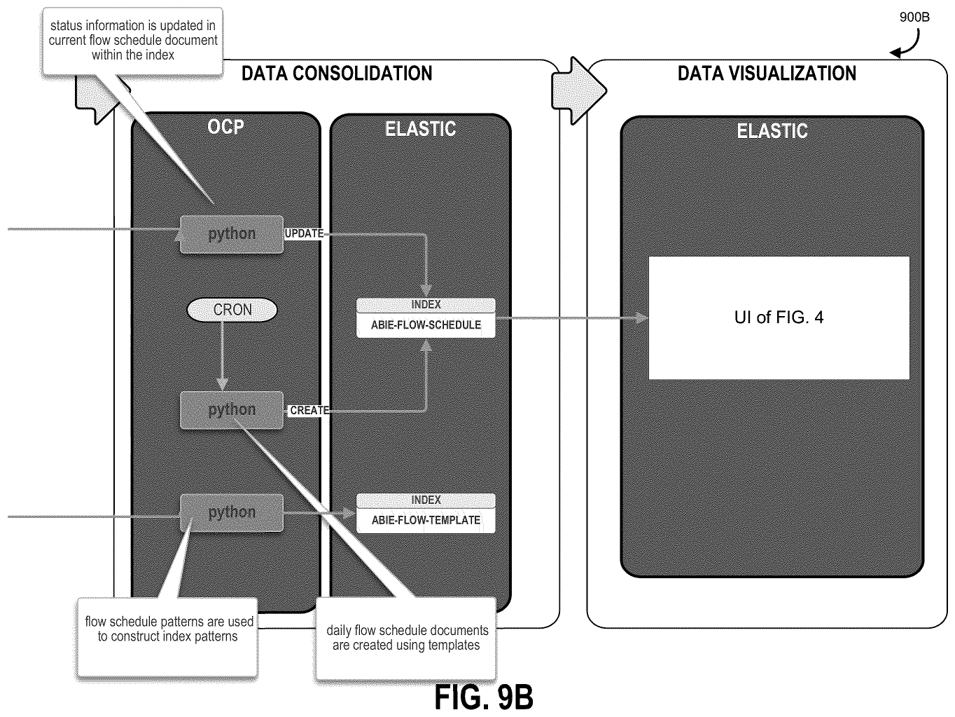

FIG. 9A and FIG. 9B is an illustration depicting an example process flow, according to some embodiments. FIG. 9A at 900A extends to FIG. 9B at 900B.

In FIG. 9A and FIG. 9B, an approach is shown where a computing device (e.g., the mainframe), on each LPAR, has Operlog source data resides thereon.

Operlog has the output of JCL and Zeke data that the system will be ingesting and/or enriching. This can be near real time data from each LPAR. Maintaining the state between LPARs is not always required.

GDG datasets represent static data from different sources. In a practical example, the two GDGs represent Zeke scheduling data that is created using a weekly JCL leveraging Zeke utility.

The other GDG dataset can be the source of application data that is ingested/enriched on a search mechanism.

Each Common Data Provider (CDP) plugin serves as the log forwarder from the Mainframe to Logstash on OCP. CDP runs on a region in all LPARS on the mainframe as independent processes. Data is forwarded using TCP protocol.

Definitions are provided below:
Logstash: Data is forwarded to elastic using the elastic output plugin including certificate validation and encryption. Secrets are injected using Vault.
Search: A Search Cloud Enterprise that is a cloud enterprise managed architecture for storing all of the time series data.
Data Consolidation: 2 Cron Jobs are running and the elastic API are utilized to read/upsert utilization and logs.

In this example, the system is configured to conduct data extraction and ingestion based on stored log files. The batch process information can be extracted and processed, including, for example, event and scheduling data. This data can then be transformed and enriched by extending the data with additional information based on data consolidation.

During the data consolidation step, flow schedule patterns can be used to construct index patterns, and a daily flow schedule can be created. The search mechanism can be used for downstream batch process visualization, or in some embodiments, batch process orchestration and control.

Once the patterns are determined, the system is able to identify batch issues, either in real-time or near-real time. The batch issues can be identified, for example, as certain batch processes begin late, have late dependencies, have forced stop/completion events, etc., as reflected in log information. The patterns can be utilized to generate downstream execution scenarios taking into account the failures and delays, and expected timing and execution status.

In some embodiments, these execution scenarios can be provided to a visualization engine so that an administrator is able to view the projected outcomes, and further, in some embodiments, the information is additionally enriched with impact information that can be based on an interrogation of the payloads of the batch processes, so that the impact can be assessed.

In a further variation, the scenario information is provided to an orchestration engine, which can be guided by the administrator or automated to invoke remediation or notification functions based on the processing of the batch flows. The remediation functions can include the re-routing or modification of timing of batch processes. The batch process and corresponding timing can be modified through the changing of execution parameters of the batch process, or changing environmental parameters of the batch process.

Each batch process can be modelled as a nodal data object having a probabilistic path weight that is adjusted in accordance with historical success or failure event data. Each path can also be coupled with timing parameters that can be adjusted, for example, by adding additional compute resources, or conversely, reducing compute resources.

For example, computing resources and processing time can be re-allocated or redistributed, or additional computing resources or processing time can be obtained from a pool of available resources. These can be applied in priority order to different batch processes as they run in an attempt to “speed up” certain batch processes.

Different timing scenarios can be modelled, and an overall scenario having the least overall impacted payloads or the overall scenario that best fits a timing constraint can be controlled to occur. In some embodiments, a plurality of scenarios are generated based on timing pattern data, the scenario that best optimizes an optimization function that is a weighted combination of impact, cost, and/or timing constraints can be selected for implementation.

An example weighted combination can include a batch process control optimization approach that prioritizes reducing the total number of payload items (e.g., transactions) that are delayed beyond a pre-defined time (e.g., the settlement time for a day). Different paths and batch processes, once a delay is identified at an earlier stage, are identified for “speeding up”. The downstream batch processes and combinations thereof are mapped together and traversed to identify a total time of execution, and the total number of payload processes that can be completed before the pre-defined time, for the existing scenario. In a simplified example, a subset of path weights can be identified for modification, and each of these different combinations of modification can be treated as a different scenario.

For example, based a real or near-real time analysis of the log data, there may be 12 batch processes that will not be completed by the 8 PM settlement time, and the current time is 2 PM. These 12 batch processes have their payloads interrogated and the payloads represent 175,000 payment transaction messages. The batch process impact evaluation engine then generates different visualizations and outputs based on the expected delay. An orchestration and control engine can be adapted to then to automatically control the batch processes to reduce the number of payment transactions that are delayed beyond 8 PM. A pool of available compute resources or time can be made available as a pool of available resources, and these resources can be evaluated in different scenarios to modify interconnections between the batch processes and their expected operational status. The scenario having the least payment transaction messages delayed beyond 8 PM can be selected, and this can include spinning up additional computing resources (or re-allocating from other processes) such that certain computing tasks can be conducted in parallel where possible or with less computational bottlenecks. As a result, for example, only 1 batch process is left executing after 8 PM, and it only represents 5,000 payment transaction messages. In a variation, instead of a total number of payment transaction messages, instead, the dollar amount of the transactions in the messages is optimized.

Where the expected execution times, delays, exceed thresholds, the system can be configured to automatically execute remedial processes or generate remedial instructions for a confirmation. These instructions can include high level commands such as expedite process #1, de-prioritize process #2, ensure process #3 finishes by 5:30 PM EST, etc. These instructions can then be translated into machine commands that control specific operational characteristics, such as changing thread/processor priority, assigning more processor cores, assigning additional computing devices, sharding or otherwise portioning larger batch jobs, or substituting data sets, sources with potentially lower quality or stale versions thereof (to be flagged during execution as reduced quality). When executed, these machine commands will automatically change execution parameters of the underlying batch processes by dynamically assigning or reassigning computing resources and priority, as well as potentially rescheduling or flagging a batch process for low data quality (e.g., if a high quality source is not available and swapped for a low quality/stale data source so that the report process can be run by the execution deadline). These can include low level machine operations such as changing a clock rate/speed of a processor (at the cost of a reduced safety margin temperature and processor longevity, power demands), reducing a backup/disaster recovery rate/bandwidth, applying hardware acceleration. As modern hardware have additional safety tolerance, there may be a potential to obtain performance improvements while being mindful of finite performance limits and downstream impacts to hardware stability. For example, a hardware failure level can also be modelled (e.g., computer memory failure as a function of increased operation speed) and used during the process traversal as part of the expected runtime.

The specialized computing apparatus can reside in a data center and can be electronically coupled to downstream computing resources and batch processing machines, and in some embodiments, can be a computer software that can control resource allocation, such as a hypervisor, a supervisor system, or a supervisor of supervisor systems, which propagate instruction sets and execution commands that are utilized to modify computer execution aspects such as hardware control and operating system control.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

I claim/we claim:

1. A computer implemented system for automated batch data process impact evaluation, the computer implemented system including a computer processor operating in conjunction with computer memory, the computer processor configured to:
extract one or more operational logs corresponding to execution of one or more data processes representing one or more batch data process jobs, each of the one or more operational logs including fields corresponding to batch flow status, batch flow payload, and batch flow schedule;
identify, from the one or more operational logs and the fields corresponding to batch flow payload, an estimated impact value of each batch data process job of the one or more batch data process jobs;
monitor the execution of the one or more data processes using the fields corresponding to batch flow status to identify differences with the fields corresponding to the batch flow schedule; and
generate an alert, notification, or control instruction if weighted differences in timing of the batch flow schedule exceeds a pre-defined threshold, the weighted differences weighted based on the estimated impact value of each batch data process job.

2. The computer implemented system of claim 1, wherein the control instruction includes re-allocating available computing resources to reduce the weighted differences in timing of the batch flow schedule by expediting a subset of the one or more batch data process jobs through allocating additional computing resources.

3. The computer implemented system of claim 2, wherein the processor is further configured to identify, from the fields corresponding to the batch flow schedule, one or more batch flow dependencies, and the one or more batch flow processes and batch flow dependencies are modelled as a set of interconnected nodal data objects that are traversed during the identification of the differences with the fields corresponding to the batch flow schedule.

4. The computer implemented system of claim 3, wherein the weighted differences are generated based on a traversal of the interconnected nodal data objects, and the traversal of the interconnected nodal data objects includes generating a probability adjusted path weight based on probability metadata stored thereon each of the interconnected nodal data objects indicative of historical success or failure event data.

5. The computer implemented system of claim 3, wherein the interconnected nodal data objects are utilized to render interactive control elements of a graphical user interface.

6. The computer implemented system of claim 2, wherein the re-allocating of the available computing resources is prioritized for a currently dispatched batch data process having a highest estimated impact value.

7. The computer implemented system of claim 5, wherein the interactive control elements include one or more graphical display options that are modified based at least upon the weighted differences in timing of the batch flow schedule for the corresponding nodal data object.

8. The computer implemented system of claim 1, wherein the re-allocating of available computing resources includes requesting additional available computing resources to be provisioned.

9. The computer implemented system of claim 1, wherein the re-allocating of available computing resources includes re-assigning computing resources from lower impact batch data processes.

10. The computer implemented system of claim 1, wherein the batch data processes are mainframe data processes.

11. A computer implemented method for automated batch data process impact evaluation, the computer implemented method comprising:
extracting one or more operational logs corresponding to execution of one or more data processes representing one or more batch data process jobs, each of the one or more operational logs including fields corresponding to batch flow status, batch flow payload, and batch flow schedule;
identifying, from the one or more operational logs and the fields corresponding to batch flow payload, an estimated impact value of each batch data process job of the one or more batch data process jobs;
monitoring the execution of the one or more data processes using the fields corresponding to batch flow status to identify differences with the fields corresponding to the batch flow schedule; and
generating an alert, notification, or control instruction if weighted differences in timing of the batch flow schedule exceeds a pre-defined threshold, the weighted differences weighted based on the estimated impact value of each batch data process job.

12. The computer implemented method of claim 11, wherein the control instruction includes re-allocating available computing resources to reduce the weighted differences in timing of the batch flow schedule by expediting a subset of the one or more batch data process jobs through allocating additional computing resources.

13. The computer implemented method of claim 12, further comprising identifying, from the fields corresponding to the batch flow schedule, one or more batch flow dependencies, and the one or more batch flow processes and batch flow dependencies are modelled as a set of interconnected nodal data objects that are traversed during the identification of the differences with the fields corresponding to the batch flow schedule.

14. The computer implemented method of claim 13, wherein the weighted differences are generated based on a traversal of the interconnected nodal data objects, and the traversal of the interconnected nodal data objects includes generating a probability adjusted path weight based on probability metadata stored thereon each of the interconnected nodal data objects indicative of historical success or failure event data.

15. The computer implemented method of claim 13, wherein the interconnected nodal data objects are utilized to render interactive control elements of a graphical user interface.

16. The computer implemented method of claim 12, wherein the re-allocating of the available computing resources is prioritized for a currently dispatched batch data process having a highest estimated impact value.

17. The computer implemented method of claim 15, wherein the interactive control elements include one or more graphical display options that are modified based at least upon the weighted differences in timing of the batch flow schedule for the corresponding nodal data object.

18. The computer implemented method of claim 11, wherein the re-allocating of available computing resources includes requesting additional available computing resources to be provisioned.

19. The computer implemented method of claim 11, wherein the re-allocating of available computing resources includes re-assigning computing resources from lower impact batch data processes.

20. A non-transitory computer readable medium, storing machine interpretable instructions, which when executed, cause a processor to perform a method for automated batch data process impact evaluation, the computer implemented method comprising:
extracting one or more operational logs corresponding to execution of one or more data processes representing one or more batch data process jobs, each of the one or more operational logs including fields corresponding to batch flow status, batch flow payload, and batch flow schedule;
identifying, from the one or more operational logs and the fields corresponding to batch flow payload, an estimated impact value of each batch data process job of the one or more batch data process jobs;
monitoring the execution of the one or more data processes using the fields corresponding to batch flow status to identify differences with the fields corresponding to the batch flow schedule; and
generating an alert, notification, or control instruction if weighted differences in timing of the batch flow schedule exceeds a pre-defined threshold, the weighted differences weighted based on the estimated impact value of each batch data process job.
